(19) United States
(12) Patent Application Publication
(10) Pub. No.: US 2017/0225974 A1
(43) Pub. Date: Aug. 10, 2017

(54) Self-Contained Desalination Unit

(71) Applicant: Reliable One Resources Inc., Lake Tahoe, NV (US)

(72) Inventors: Derek Mans, Colorado Springs, CO (US); Tom Warnes, Silverthorne, CO (US)

(21) Appl. No.: 15/400,986

(22) Filed: Jan. 7, 2017

Related U.S. Application Data
(63) Continuation-in-part of application No. 15/280,540, filed on Sep. 29, 2016.
(60) Provisional application No. 62/234,892, filed on Sep. 30, 2015.
(60) Provisional application No. 62/276,598, filed on Jan. 8, 2016.

(51) Int. Cl. C02F 1/44; B01D 65/02; B01D 63/08; C02F 1/40; B01D 17/02

(52) U.S. Cl. CPC C02F 1/44; C02F 1/40; B01D 17/0214; B01D 63/08; B01D 65/02; C02F 2001/007

(57) ABSTRACT

A system and method for the desalination of a wastewater stream. The system has an inlet pipe which directs wastewater stream which has saline water to a settling and separation bowl. The bowl has a filtration membrane located within the separation bowl. The bowl further has an outlet pipe to direct cleaned water out of the settling bowl.

### PRIORITY

The present invention is a continuation-in-part of Ser. No. 15/280,540 entitled “Self-Contained Water and Oil Separator” filed Sep. 29, 2016, the entirety of which is hereby incorporated by reference, which said application claims priority to U.S. Provisional Application No. 62/234,892 entitled “Self-Contained Water and Oil Separator” filed Sep. 30, 2015 which is hereby incorporated by reference. The present invention further claims priority to U.S. Provisional Application No. 62/276,598 entitled “Self-Contained Desalination Unit” filed on Jan. 8, 2016, the entirety of which is hereby incorporated by reference.

### BACKGROUND OF THE INVENTION

Technical Field

The present invention relates to a medium volume self-contained desalination unit utilizing an endless belt membrane with very high flux rates and high fouling resistance.

Description of Related Art

Commercial and industrial activities often produce wastewater streams with salt ions entrapped or entrained within the water. Disposal of salt water is expensive and may require environmental mitigation or hazardous waste disposal. Furthermore, water contaminated with salts is unusable for discharge, irrigation, or drinking. Current technology to remove salts from water is expensive, cumbersome, requires excessive power, and has an extremely large footprint. Consequently, there is a need for a less expensive system and method for desalination.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a schematic view of the oil separator in one embodiment;

FIG. 2 is a schematic view of the oil separator in another embodiment.

FIG. 3 is a schematic view of the desalination unit in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

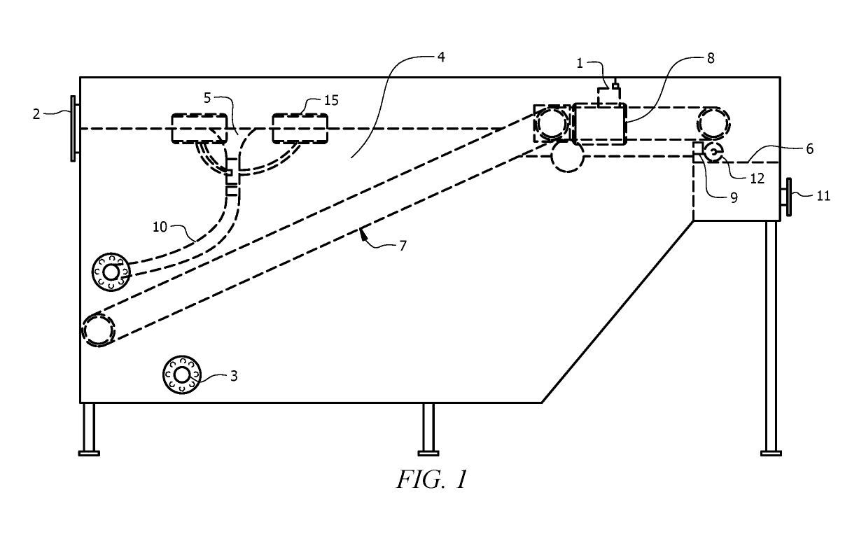

Turning now to FIG. 1, FIG. 1 is a schematic view of the oil separator in one embodiment. This figure is for illustrative purposes only and should not be deemed limiting. In one embodiment, and as depicted, the separator comprises one single vessel offering a reduced footprint compared to prior separators.

In one embodiment, the power input 2 provides power to the separator. The power input 1 can be connected to the electrical grid, a generator, batteries, solar power, solar panels, etc. In one embodiment the power input 1 comprises an electric motor. In one further embodiment the power input 1 comprises a DC motor with an integral gear box. In other embodiments the power input 1 can comprise motors without gearboxes such as direct drive motors, AC motors, both with and without gearboxes. Those skilled in the art will understand the sizing and power requirements necessary for the power input 1.

The separation unit can comprise virtually any size dependent upon the desired flow rate. In one embodiment the unit comprises a size of about 3 feet tall, 8 feet in length, and about 4 feet wide. This is for illustrative purposes only and should not be deemed limiting.

As depicted, contaminated water is introduced to the settling and separating bowl 4 through the inlet pipe 2. This is for illustrative purposes only and should not be deemed limiting. The contaminated water can be introduced into the bowl via any method or device known in the art.

The flow rate of contaminated water will depend upon several factors, including but not limited to, the size of the separation unit, the chemical composition of the contaminated water, and other factors. The flow rate will also be dependent upon the substrate and chemical composition of the membrane, discussed in more detail below. In one embodiment the separator unit is sized to receive between about 5 and 50 gallons per minute. As noted, this flow rate can be scaled upward or downward depending upon the system requirements.

As used herein, contaminated water comprises water and at least one hydrocarbon, such as oil, in undesirable quantities. In one embodiment contaminated water comprises hydrocarbons in amount up to and above 250,000 ppm. The contaminated water can further contain other contaminates such as chlorides, aluminums, arsenic, beryllium, boron, cadium, chromium, cobalt, copper, fluoride, iron, lead, lithium, manganese, molybdenum, nickel, selenium, vanadium, and zinc. In one embodiment, contaminated water comprises contaminants in a greater concentration which is typically allowed for drinking water. In another embodiment the contaminants can include benzene, toluene, ethylbenzene, zylene, polycyclic aromatic hydrocarbons, naturally occurring radioactive materials (NORMS), heavy metals and other volatile organic compounds (VOC). Other contaminants can include fracking or drilling chemicals, volatile and semi volatile organic compounds, salts, methylene chloride, formaldehyde, chloroform, bromodichloromethane, In one embodiment the separation unit removes and separates many of these contaminants from the contaminated water.

While in one embodiment the separation of oil will be described, this is for illustrative purposes only and should not be deemed limiting. While the separation unit separates oil, it also separates other contaminates including other hydrocarbons.

The size and configuration of the separating bowl, in one embodiment, are designed to reduce the turbulence inside the bowl. This helps contaminants such as oil to separate from the water and float to the surface. Oil that separates from the water will float to the top of the bowl and be removed by the weir oil skimmer 5.

The weir oil skimmer 5, in one embodiment, pipes recovered oil directly into the recovered oil tank 6. In one embodiment recovered oil refers to a substance which is greater than 50% by weight contaminants. As depicted the weir oil skimmer 5 is fluidly connected to an oil skimmer recovery pipe 10. In one embodiment the oil skimmer recovery pipe is flexible which allows the weir oil skimmer 5 to bob and float along the surface. In other embodiments the oil skimmer recovery pipe is rigid, holding the weir oil skimmer 5 in one specific and fixed location. In one embodiment the oil skimmer recovery pipe 10 is fluidly connected to the recovered oil tank 6. As depicted, the weir is supported by one or more floats 15. These floats 15 float upon the surface of the water. The height of the weir 5 relative to the floats 15 can be adjusted and fine-tuned in order to ensure that only the top layer of the contaminants is introduced and recovered by the weir 5. If the user determines that water is being introduced into the weir 5, then the height of the weir 5 needs to be increased.

In one embodiment oil, hydrocarbons, and other contaminants float to the top of the water bowl whereby they are captured by the weir oil skimmer 5 which is positioned so that it captures only the top layer of contaminants. In some embodiments the hydrocarbons, oil, and other contaminants will form a phase break and rise to the top forming a top layer of contaminants. By adjusting the height of the weir oil skimmer 5 to coincide with the location of the top layer, a high concentration of contaminants can be removed via the skimmer 5. This increases efficiency of the oil separator by preventing these contaminants from needing to be removed by the separator filter belt, as discussed below.

As noted, in one embodiment the height and location of the skimmer 5 can be adjusted. The height of the skimmer 5 can depend upon a variety of factors including the volume in the bowl 4, as well as the type and concentration of the contaminants in the water.

Various types of skimmers can be utilized. In one embodiment a floating weir skimmer manufactured by Megator Corporation of Pittsburgh Pa. is used. The weir has a floating skimmer and a variable weir as well as a sliding shoe pump. The weir can comprise virtually any material including stainless steel, thermoplastic, other stainless and ferrous steels, carbon composites, rubber, fiberglass, and other metals. The pump associated with the weir, not depicted, in one embodiment can comprise any designated self-priming pump designed for transferring flammable and/or explosive materials.

Also depicted as being located in the settling and separating bowl 4 is the oil separator filter belt 7. The oil separator filter belt 7 will aggregate entrapped and entrained oil, allowing the oil skimmer 5 to remove the oil out of the settling and separating bowl 4. The oil separator filter belt 7 also removes debris from the water as it travels. In operation, as the oil separator filter belt 7 passes through the bowl 4, entrained and entrapped oil attach to the surface of the belt 7. The belt 7 is then directed to the top of the bowl 4. Aggregated oil is then allowed to float to the top of the bowl where it is collected by the skimmer 5.

The separator filter belt 7 breaks the bowl 4 into two segments: an upstream segment and a downstream segment. An upstream segment, as used herein, refers to a portion of the bowl 4 which is closer to the inlet pipe 2 and which is to the inlet pipe 2 side of the filter belt 7. A downstream segment, as used herein, refers to a portion of the bowl 4 which is beyond the filter belt 7. Referring to FIG. 1, the left side of the figure above the filter belt 7 is the upstream segment whereas the right side of the figure below the filter belt 7 is the downstream segment. In one embodiment water and contaminants must pass through the filter belt 7 before they can advance to the downstream segment. As such, in some embodiments, the filter belt 7 acts as a physical barrier between the upstream segment and the downstream segment. In one embodiment contaminated water is located in the upstream segment whereas cleaned water is located in the downstream segment.

The separator filter belt 7 in one embodiment serves multiple purposes. First, the filter belt 7 acts as an oil water separator. Second, the filter belt 7 acts as a filtration device.

The separator filter belt 7 can comprise a variety of materials. In one embodiment the filter belt 7 comprises an oil phobic material such that water passes through the belt and oil remains behind on the belt 7 to be later skimmed off the surface of the bowl 4 by the skimmer 5. Thus, the separator belt 7 acts as a filter to capture solids and other particulates and components located in the contaminated water. Because the belt 7 acts as a filter, the filter screen size can be varied and adjusted to allow or remove the desired contaminants. The screen size on the filter, for those embodiments utilizing a screen, can be adjusted depending upon the contaminants, the concentration, flow rate, etc.

The belt 7 can comprise metals, fabric, cotton, polyester, rubber, polypropylene, carbon composite, fiberglass, and virtually any other material that has the ability to be perforated. In one embodiment the belt comprises a mesh screen. In other embodiments the belt comprises a screen material made from any of the above materials as well as fiberglass, poly blends, brass, stainless steel, copper, titanium, and fabric. In one embodiment the belt comprises a conveyor belt such as a chain drive with a membrane located atop the chain. In one embodiment the belt is 36 inches wide with a balanced Mesh B-72-24-16-16WD, made of T304 with welded selvages. The chain is RC40 T304 stainless steel.

As can be seen, the belt is driven by a variety of rollers, sprockets, etc. These can comprise virtually any material, including any of the metals, composites, or thermoplastics disclosed herein.

As noted, in one embodiment the belt 7 is coated with a membrane. In one embodiment the membrane is oil phobic which prevents a portion of the oil, grease, and paraffin from passing through the membrane. These contaminants, instead, are collected atop the membrane. In one embodiment the membrane comprises an oil repellant.

In one embodiment the belt 7 is coupled to the bowl 4 via seals. The seals prevent contaminated water from circumventing the belt 7 and reaching the downstream end without passing through the belt 7. Virtually any type of seal which can be coupled to a belt can be used. In one embodiment the seal assembly is a metal shape with an integrated seal. The metal shapes can comprise any structural shape of virtually any material. In one embodiment the integrated seal comprises neoprene, viton, and other rubber and plastic based materials and composites.

In one embodiment, the separator system further includes an air blade 9 which is positioned adjacent to a portion of the belt 7. An air blade 9 blows through the oil separator belt 7, cleaning debris from the filter. In one embodiment, and as depicted, the air blade 9 is positioned above the recovered oil tank 6. An air blade 9 pushes air through the belt 7. As it does this, contaminants are forced from the belt 7 and are recovered in the recovered oil tank 6. This cleans the belt 7 before it is reintroduced into the bowl.

Virtually any device which cleans the belt 7 can be utilized. Additional devices include water knives, bristles and brushes, etc., which will all act to grab and remove contaminants from the belt 7. The air knife 9 has several advantages including elimination of a separate water stream. The size, power, and location of the air knife 9 can be adjusted depending upon the desired embodiment. The materials for the air knife can include thermoplastics, stainless, ferrous steels, carbon composites, rubber, metals, etc. The blower units used in the air knife can be air blowers or air compressors. In one embodiment an air knife 9 system comprises an air knife manufactured by Air Control Industries, Inc. of Windos Me.

In one embodiment, the debris removal auger 12 carries debris to the outside of the machine. As depicted, the belt 7 is driven by a belt drive motor 8. The motor 8 can comprise any motor or engine known in the art.

Recovered oil is collected in the recovered oil tank 6. In one embodiment the recovered oil tank 6 comprises a separate vessel than the separator. In another embodiment, and as depicted, the recovered oil tank 6 is located within the same vessel as the separator but is separated within that vessel to prevent mixing of the recovered oil with the bowl 4. The recovered oil pipe 11 carries the recovered oil away from the recovered oil tank 6 for subsequent disposal or reprocessing.

Cleaned water exits the separator through the water outlet pipe 3 located near the bottom of the separator. In one embodiment, the water outlet pipe 3 is located on the downstream segment of the separator unit. The cleaned water can then be disposed or treated further.

In one embodiment, a medium volume self-contained oil contaminated water oil separator and dewatering filter incorporating redundant floating weir oil skimmer is disclosed. In one embodiment the separator is a unique integration and enhancement of oil water separation and filtration technologies to provide an environmentally friendly, scalable, ultra-high efficiency, reduced footprint oil water separation and filtration system. The technology can be adapted, tuned, and utilized for new, existing, temporary, or emergency facilities. This technology is environmentally green. In one embodiment the separator benefits environmental remediation, industrial plant owners, downstream water users, and any other oil from water reclamation activities. This technology can be utilized either in parallel to increase flow rates of wastewater treatment, or in series, to eliminate virtually all oil from a water stream.

In one embodiment the separator utilizes two methods of oil separation from water. First, a gravity separation as described in Stokes Law is performed in the settling and separating bowl 4. The gravity separation is accomplished via the floating weir skimmer 5. As noted, the floating weir skimmer 5 discharges the skimmed oil directly into the recovered oil tank 6. Many oil globules suspended in the water will be too small to separate from the water on a gravity separation basis, so a second recovery method consisting of a filter mesh is incorporated in the system. In one embodiment the filter belt 7 described above comprises a filter mesh. The filter mesh allows water to pass through but separates oil molecules. The oil molecules are aggregated on the filter on the belt 7 in the settling and separating bowl 4, where they are removed from the water via the floating weir skimmer 5. Due to the enhanced oil recovery methods provided in this system, it operates using less power and in a more confined space than competing products. Its ability to recover more oil from wastewater streams utilizing a smaller footprint and less power makes this an environmentally friendly solution to oil water separation and cleanup activities.

Via the utilization of bleeding edge technologies, this unit is less expensive, more power efficient, weighs less, has a smaller footprint, and removes higher percentages of oil from wastewater streams than current technologies offer. For example, other prior oil water separators rely on extended settling periods for adequate separation, and are unable to separate extremely small and entrapped oil particles. Due to their need to settle, they are very large permanent structures. Mechanized systems are also extremely large and permanent, and are extremely power inefficient. However, the instant separator removes much more oil from wastewater much more efficiently, is smaller, lighter, portable, and can be operated in temporary and emergency process streams. This invention uses less energy than competing products and is therefore environmentally friendly. The ability to recover higher percentages of oil that would normally either be disposed of or discharged also qualifies this invention as environmentally friendly.

In operation, in one embodiment, the separator will be optimized for various industries and applications. For example, depending on the industry where the unit is deployed, adjustments will be necessary for the required water volume per time unit, as well as the oil content of the water. Multiple units will be able to be utilized in parallel to increase the total system capacity without affecting overall performance. In one embodiment, the separator can be made by procuring the elements matched to the overall system operating requirements (e.g., flow rate, oil content of water) and assembling into the integrated system. The speed and efficiency of the separator can be controlled and adjusted as necessary by changing, modifying, or scaling one or more parts of the separator. As but one non-limiting example, the material of the belt can affect the quantity of oil caught by the belt.

In one embodiment, to use the invention, the unit will be mounted in an appropriate place, with water lines and oil line correctly connected and routed. Power must be provided to the unit. The unit must be tuned properly, including weir height, belt feed speed, and air volume and force for debris removal.

The separator can be utilized in multiple applications and industries, including emergency cleanup operations, where water comes into contact with petroleum or natural oils and fats. The unit is sized so that transportation is relatively easy, allowing the unit to be deployed in remote or temporary locations easily.

In one embodiment, cleaned water refers to a water whose contaminants have been reduced by greater than 75% of the entering contaminants. In other embodiments the contaminants have been reduced between 75% and 95% of the entering contaminants.

In one embodiment the separation unit will be used as the first operation in a process stream. The contaminated water entering the separation unit is fairly dirty and full of oil, grease, and paraffin. Based on the systems and methods discussed herein, the contaminants in the clean water can be reduced by greater than 75% of the entering contaminants. If the incoming water contains a high percentage of extremely fine solids, such as silt or clay, the separation unit can be modified as necessary to capture the finer particulates. As but one example, a finer membrane can be applied to the belt to grab and capture the finer particulates.

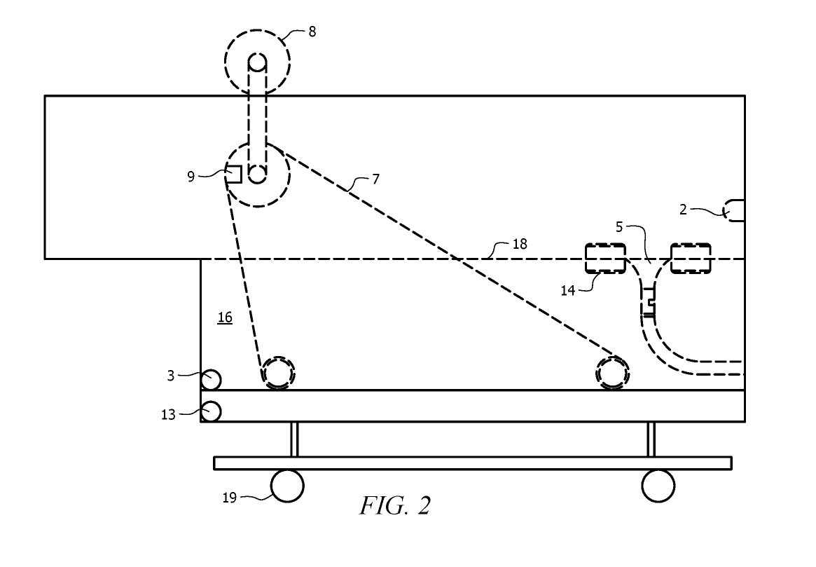

FIG. 2 is a schematic of another embodiment of the separation unit. Like numerals reference the same items found in FIG. 1. As can be seen, FIG. 2 shows an upstream segment 14 and a downstream segment 16. Contaminated water enters through inlet 2 and is introduced into the upstream segment 14. The weir 5 is positioned to float atop of the water level 18. As depicted the weir is supported by floats 15. Accordingly, as previously discussed, light contaminants, including hydrocarbon and oil, will rise to the top of the water level 18. At the top, they can be skimmed by skimmer 5. The water then passes through the belt 7 which separates the upstream 14 and the downstream 16 segments. In one embodiment the belt 7 grabs oil and other contaminants as well as acts as a filter to filter the water. Clean water is removed at exit 3 which is located in the downstream segment 16. The system also includes a drain 13.

The unit depicted is located upon wheels 19. This allows the unit to be moved, transported, and placed in its desired location. The wheels 19 are for illustrative purposes only and should not be deemed limiting. In other embodiments skids or the equivalent can be utilized.

In still other embodiments the unit comprises a permanent structure which is not built to be easily transportable. This will be dependent upon the flow rate, the design size, etc. of the separation unit.

In one embodiment the separation unit is built from a standard shipping container. The shipping container provides the exterior structural walls of the separation unit.

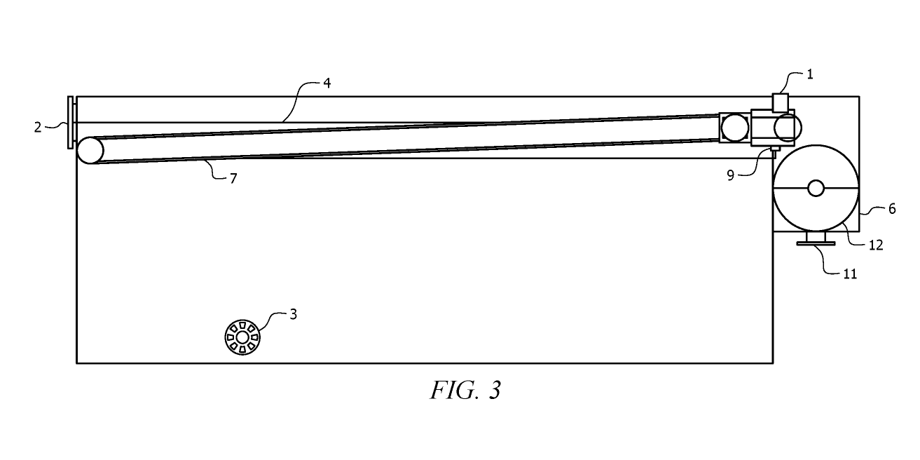

Turning now to FIG. 3, FIG. 3 is a schematic view of the desalination unit in one embodiment. This figure is for illustrative purposes only and should not be deemed limiting. In one embodiment, and as depicted, the desalination unit comprises one single vessel offering a reduced footprint compared to prior separators. In one embodiment the desalination unit can be built in similar structure and size to the separation unit. Thus, many of the same parts which were discussed in great detail with respect to the separation unit are applicable to the below discussion regarding the desalination unit.

In one embodiment, the power input 1 provides electrical power to the unit. As stated above, the power input 1 can be connected to the electrical grid, a generator, batteries, solar power, solar panels, etc.

Saline water is introduced to the settling and separating bowl 4 through the inlet pipe 2. The makeup of the entering water can be similar or different than discussed above. In one embodiment saline water comprises water and salt ions. As discussed above, in one embodiment, the size and configuration of the separating bowl, in one embodiment, are designed to reduce the turbulence inside the bowl.

Also depicted as being located in the settling and separating bowl 4 is the filtration membrane. The filtration membrane, in one embodiment, comprises an endless filtration membrane such as a belt 7. The membrane can comprise the same or different materials than those addressed above. In one embodiment, the filtration membrane Salt ions suspended in the incoming water will become entrapped in the pores of the filtration membrane 6 as the saline water passes through the membrane.

In one embodiment the filtration membrane 7 carries the entrapped salt ions upward and out of the settling bowl 4. In one embodiment, and as depicted, the filtration membrane 6 is in communication with an air blade 8. In one embodiment, an air blade 9 blows through the filtration membrane 6, cleaning and removing ions from the membrane pores. As the membrane 7 passes over the air blade 8 the ions are allowed to disassociate. In one embodiment, and as depicted, the air blade 9 is positioned above the recovered sludge reservoir 6. In one embodiment the air knife has a narrow aim and is used to blow out contaminants.

The specific filtration membrane 7 can be adjusted depending upon the volume of saline water, the desired salt concentration removed, the speed of the filtration membrane 6, as well as other factors. Those skilled in the art will understand how to vary attributes of the filtration membrane 7 such as size, shape, medium, etc. to achieve a desired result. In one embodiment the filtration membrane 7 comprises a high strength, high flux, geometrically segmented, foul resistant surface. A higher efficiency salt ion removal membrane will result in more efficient removal of salt ions from the water with the same flow of water.

In one embodiment, the construct of the membrane is one of segmented geometric overlapping shapes, which allows for a watertight seal that traps salt ions while allowing water molecules to pass through. The construct of the membrane also allows for it to be separated at the air knife 9 for efficiency of cleaning, as previously described. In one embodiment, the membrane incorporates a unique combination of high flux rates 100 to 1000 times greater than current ultrafiltration membranes. In some embodiments, the membranes can recover from fouling without the need for chemicals and the pore sizes can be tuned to specific salt ions, allowing for selective removal and recovery of individual, or all, salts in the incoming water stream. The endless filter, in conjunction with constant cleaning, allows for excellent salt ion removal capabilities, low maintenance, and extremely low power usage per volume of water, especially in comparison to traditional desalination methods.

The removed salt ions, as well as other suspended solids which are entrapped by the filtration membrane 7, are deposited in the sludge reservoir 6. In one embodiment, a debris removal auger 12 carries debris, removed salt ions, and other suspended solids deposited into the sludge reservoir 6 to the outside of the machine. In one embodiment the debris removal auger 12 comprises a screw auger. While a screw auger is discussed, this is for illustrative purposes only and should not be deemed limiting. Virtually any equipment which transports solids or entrained solids from the sludge reservoir 6 can be utilized. The debris removal auger 12 transports the solids from the sludge reservoir to outside of the machine for subsequent disposal or reprocessing. In one embodiment, the recovered salts are deposited in a sludge tank, where they are dewatered and carried outside the machine for either disposal or reuse.

After the salt ions and other solids have been cleaned via the air blade 8, the cleaned filtration membrane 6 returns to the settling tank 4 to continue the salt ion filtration process. The process is repeated and additional salt ions are removed from the settling tank 4 and deposited into the sludge reservoir 6.

As depicted, the filtration membrane 7 is driven by a belt drive motor. The motor can comprise any motor or engine known in the art.

Cleaned water exits the desalination unit through the water outlet pipe 3 located near the bottom of the tank. The cleaned water can then be disposed or treated further. The cleaned water can be similar to the water properties discussed above. In one embodiment the cleaned water has less than 500 ppm chlorides for irrigation and less than 240 ppm chlorides for drinking water.

In one embodiment, a unique integration and enhancement of proprietary high strength, high flux, geometrically segmented, foul resistant, salt ion capturing membrane, stainless steel substrate, and membrane conveying, cleaning, and housing technologies to provide an environmentally friendly, scalable, ultra-high efficiency, reduced footprint, ultra-energy efficient water desalination and filtration system is disclosed. By integration and utilization of new and enhanced mechanical technologies, this unit reduces initial startup costs and maintenance costs, as well as being extremely power efficient and operating in a small, compact, and portable unit.

Via the utilization of bleeding edge technologies, this unit is less expensive, more power efficient, weighs less, has a smaller footprint, and removes a higher percentage of salts from wastewater streams than current technologies offer. Additionally, this unit can be tuned to either remove all salt ions or select salt ions from the wastewater stream.

The technology can be adapted, tuned, and utilized for new, existing, temporary, or emergency facilities, as well as selective or partial removal of salt ions, either individually or collectively. Additionally, this technology can be utilized either in parallel to increase flow rates of water treatment, or in series, to selectively eliminate and separate different salt ions.

Further, this technology is environmentally friendly. The instant unit removes much more salts from wastewater much more efficiently, is smaller, lighter, portable, and can be operated in temporary and emergency process streams. The unit uses less energy than competing products and is therefore environmentally friendly. The ability to recover higher percentages of salts which would normally either be disposed of or discharged also qualifies this invention as environmentally friendly.

Current desalination technologies primarily rely either on thermal distillation of wastewater in order to remove salts, or on chemical salt separation. Both of these processes are slow and require a great deal of storage capacity in order to effectively desalinate a wastewater stream. The thermal distillation process is extremely energy intensive, and water treated with this process then requires further treatment in order to reintroduce trace compounds back into the water so that it can be utilized domestically or agriculturally. Chemical separation requires the disposal of toxic chemicals as a byproduct of the treatment methodology. Both of these treatment options also require permanent structures, as the storage, equipment, and processes are too large and cumbersome to be portable. Thus, as noted above, this technology is an environmentally friendly alternative to prior technologies.

In operation, in one embodiment, the unit will be optimized for various industries and applications. For example, depending on the industry where the unit is deployed, adjustments will be necessary for the required water volume per time unit, as well as the salinity of the water. Multiple units will be able to be utilized in parallel to increase the total system capacity without affecting overall performance. In one embodiment, the unit can be made by procuring the elements matched to the overall system operating requirements (e.g., flow rate, salinity of the water) and assembling into the integrated system. The speed and efficiency of the unit can be controlled and adjusted as necessary by changing, modifying, or scaling one or more parts of the unit. As but one non-limiting example, and as described previously, the material of the membrane 7 can affect the quantity, size, and type of salt caught by the membrane 7.

In one embodiment, to use the system described, the unit will be mounted in an appropriate place, with water lines connected and routed. Power must be provided to the unit. The unit must be tuned properly, including weir height, belt feed speed, and air volume and force for debris removal.

In one embodiment the system comprises rotation control which includes a variable frequency drive. The frequency can be varied depending upon multiple factors including the contaminants and salinity of the water. The membranes can comprise a variety of materials discussed above, including stainless steel and polyester weave. In one embodiment the belt is about 34 inches wide and about 10 feet and 2 inches long, but these dimensions can be adjusted as desired.

In one embodiment sea water entering has about 33,000 to about 45,000 ppm sodium chloride. In one such embodiment the exiting water has less than 500 ppm chloride.

The unit can be utilized in multiple applications and industries, including emergency cleanup operations. In one embodiment, the unit is sized so that transportation is relatively easy, allowing the unit to be deployed in remote or temporary locations easily. There are many varied applications, including, environmental remediation projects, industrial plant owners, downstream water users, municipal process plants, and any other industries where desalination of water is desirable.

As noted, this unit, in one embodiment, removes salt ions from wastewater much more efficiently, is smaller, lighter, portable, and can be operated in temporary and emergency process streams. This unit uses substantially less energy than competing products and is therefore environmentally friendly. The ability to selectively recover differing salt ions allows water processing facilities the ability to repurpose or dispose of these different salt ions. The small footprint, recovery efficiency, and energy efficiency make this unit an ideal component in both new and remodeled water treatment plants.

While the invention has been particularly shown and described with reference to a preferred embodiment, it will be understood by those skilled in the art that various changes in form and detail may be made therein without departing from the spirit and scope of the invention.

What is claimed is:

1. A system for the desalination of a wastewater stream, said system comprising:
an inlet pipe which directs a wastewater stream comprising saline water to a settling and separating bowl;
a filtration membrane located within said settling and separating bowl to aggregate entrapped and entrained salt;
an outlet pipe which directs cleaned water out of said settling and separating bowl.

2. The system of claim further comprising an air blade.
